(19) United States
(12) Patent Application Publication
(10) Pub. No.: US 2024/0345121 A1
(43) Pub. Date: Oct. 17, 2024

(54) DISPENSING DEVICE AND DISPENSING METHOD

(71) Applicant: HITACHI HIGH-TECH CORPORATION, Tokyo (JP)

(72) Inventors: Daisuke HARA, Tokyo (JP); Masashi SHIBAHARA, Tokyo (JP); Nobutaka KUMAZAKI, Tokyo (JP)

(21) Appl. No.: 18/689,501

(22) PCT Filed: Sep. 14, 2021
(86) PCT No.: PCT/JP2021/033808

§ 371 Date: Mar. 6, 2024

(51) Int. Cl. G01N 35/10; B01L 3/02; G01F 22/02

(52) U.S. Cl. CPC G01N 35/1016; B01L 3/0237; G01F 22/02; B01L 2200/146

(57) ABSTRACT

A dispensing device has: a syringe having a piston, a first drive device driving the piston, and a tip mounting part; a block having first and second orifices; a pump; and a second drive device for varying the relative positions of the syringe and the block. A processing device: drives the second driving device and fits together the tip mounting part and the first orifice such that the interior of the syringe is hermetically sealed, and then drives the pump and applies positive or negative pressure to the interior of the syringe; and subsequently drives the second driving device and fits together the tip mounting part and the second orifice such that the interior of the syringe is hermetically sealed, and then drives the pump and applies positive or negative pressure to the interior of the syringe; and identifies the site of deterioration in the dispensing device.

### TECHNICAL FIELD

The present disclosure relates to a dispensing apparatus and a dispensing method.

### BACKGROUND ART

Dispensing apparatuses that dispense liquids such as specimens and reagents into separate containers are used in inspection devices in the medical and biological fields. The dispensing apparatus is configured by a pipette section for sucking and discharging a liquid, a tip for sucking the liquid into the inside, a transport device for transporting the pipette section and the tip, and the like.

In inspection in the medical and biological fields, small amounts of liquid samples may be handled. In this case, if the intended dispensing amount is not dispensed, the inspection results may be adversely affected, so it is required to accurately dispense the designated amount with high reproducibility.

However, due to the influence of deterioration due to the use environment, the device characteristics, aging, or the influence of disturbances in the characteristics, the state, or the like of the sample, even though pressure generation means is operated as designed, the intended dispensing amount may not be dispensed. Therefore, it is necessary to correct a dispensing command value.

PTL 1 discloses a dispensing apparatus configured to include “a pressure sensor that measures the pressure in a tube when a liquid is sucked by a dispensing probe 12c, a calculation unit 34 that calculates the average pressure value measured by the pressure sensor when the liquid is sucked, a storage unit 37 that stores the correlation between the average pressure value when the liquid of each desired discharge amount is sucked and a discharge operation amount, a correction unit 38 that corrects the discharge operation amount based on the average pressure value in suction, which has been calculated by the calculation unit 34, and the correlation stored in the storage unit 37, and a control unit 31 that controls a syringe pump to discharge the desired discharge amount based on the discharge operation amount corrected by the correction unit 38” (see Abstract in PTL 1).

PTL 2 discloses a dispensing apparatus configured as follows. “A pressure sensor connected to a dispensing probe measures pressure inside and outside a sealed liquid holding container, and an operation amount of a pump is corrected in accordance with the measured pressure amount. The operation amount of the pump is corrected by calculating a displacement amount of a dispensing flow path due to the change in pressure” (see Abstract in PTL 2).

PTL 3 discloses a technique having a “configuration in which, in a dispensing apparatus 1 including a plurality of nozzles 3 for dispensing a liquid, nozzle moving means 4 for moving the plurality of nozzles 3 in the vertical direction, and suction and discharge means 3a for sucking and collecting a liquid into a dispensing tip 5 mounted to tip ends of the plurality of nozzles 3 and discharging the sucked and collected liquid from the dispensing tip 5, a dispensing tip fitting portion 7 in which an upper surface has a plurality of opening portions 7a corresponding to the plurality of nozzles 3, and a closed space is formed therein when the plurality of dispensing tips 5 to which the plurality of nozzles 3 are mounted are fitted to the plurality of opening portions 7a, and an internal pressure detection unit 8 that detects a change in pressure in the dispensing tip fitting portion 7” (see Abstract in PTL 3).

### CITATION LIST

### Patent Literature

PTL 1: JP2011-080964A
PTL 2: JP2015-169623A
PTL 3: JP2005-337977A

### SUMMARY OF INVENTION

### Technical Problem

Dispensing devices are required to accurately suck and discharge a small amount of liquid with high reproducibility. In order to accurately suck and discharge liquid with high reproducibility, the airtightness of the dispensing apparatus is important. However, since a sealing component that isolates the inside of the dispensing apparatus from the outside air slides with the piston, a contact portion therebetween is worn or deteriorated, and thus the accuracy of dispensing is decreased. As wear or deterioration of the sealing component progresses, it is not possible to generate the intended pressure during suction and discharge, resulting in insufficient suction amount and liquid remaining during discharge. Further, even when a disposable tip for dispensing is used and an elastic member is used in a tip mounting part, attachment and detachment of the tip are repeated. Thus, the airtightness deteriorates due to wear and deterioration of the elastic member. However, by simply measuring the pressure in the dispensing device, it is not possible to determine which part requires maintenance.

In the method using the change in pressure during liquid suction, as in PTL 1, a difference between the amount of change in the average pressure value measured in dispensing a small amount and the value stored in the storage means is very small, or no difference appears. Thus, it is difficult n correction based on the correlation.

The dispensing apparatus disclosed in PTL 2 pierces the inside of a sealed container with a dispensing probe, and corrects the discharge command value in accordance with the internal pressure value. However, since the suction amount is decreased, it is necessary to correct not only the discharge amount but also the command value during the liquid suction. Although compensation for the lack of liquid amount during suction can be performed by suctioning a sufficient amount in advance, consumables such as reagents are consumed more than necessary, which can lead to increased running costs.

PTL 3 aims to prevent an occurrence of failure during dispensing by detecting malfunctions in mounting a disposable tip. In a dispensing operation, one of the important factors is that the tip is mounted without problems, but, in order to perform correction for accurate dispensing, it is necessary to measure the performance and the state of the sealing component inside the dispensing apparatus.

Therefore, the present disclosure provides a technique for enabling identifying of a deteriorated component of a dispensing device.

### Solution to Problem

In order to solve the above problems, a dispensing device according to the present disclosure is configured to dispense a liquid. The dispensing device includes a piston, a first drive device that drives the piston, a syringe that has a tip mounting part having an elastic member for mounting a dispensing tip and receives the piston, a pressure sensor that measures pressure in the syringe, a processing device that processes a detection signal of the pressure measured by the pressure sensor, a block having a first orifice and a second orifice that are able to be fitted to the tip mounting part, a pump connected to the first orifice and the second orifice, a second drive device that varies a relative position between the syringe and the block. The processing device drives the second drive device to fit the tip mounting part and the first orifice to each other, hermetically seals an interior of the syringe, and drives the pump to apply positive pressure or negative pressure into the syringe, then, drives the second drive device to fit the tip mounting part and the second orifice to each other, hermetically seals the interior of the syringe, and drives the pump to apply the positive pressure or the negative pressure into the syringe, and identifies a site of deterioration in the dispensing device based on first pressure in the syringe after generation of the positive pressure or the negative pressure when the tip mounting part and the first orifice are fitted to each other and second pressure in the syringe after generation of the positive pressure or the negative pressure when the tip mounting part and the second orifice are fitted to each other.

Further features related to the present disclosure will become clear from the description of the present specification and the accompanying drawings. In addition, aspects of the present disclosure may also be accomplished and realized by the elements, combinations of various elements, the following detailed description, and the aspects of the appended claims. The descriptions in the present specification are merely typical examples, and do not limit the scope of claims or application examples of the present disclosure in any way.

### Advantageous Effects of Invention

According to the technique of the present disclosure, it is possible to identify a deteriorated component of a dispensing device. Problems, configurations, and effects other than those described above will be made clear by the following description of the embodiments.

### BRIEF DESCRIPTION OF DRAWINGS

FIG. 1A is a schematic diagram illustrating a configuration of a dispensing apparatus of an automatic analyzer according to a first embodiment.

FIG. 1B is a schematic diagram illustrating a state in which a tip mounting unit is fitted to a hole of an inspection block.

FIG. 2 is a flowchart illustrating a method of determining whether the dispensing apparatus is usable and a method of correcting a dispensing command value.

FIG. 3A is an example of a dispensing command value map for determining the dispensing command value.

FIG. 3B is another example of the dispensing command value map for determining the dispensing command value.

FIG. 4 is a graph showing a transition waveform of a pressure value when negative pressure is applied into a tube.

FIG. 5 is a graph showing a transition waveform of the pressure value when positive pressure is applied into the tube.

FIG. 6 is a schematic diagram illustrating a configuration of an automatic analyzer according to a second embodiment.

FIG. 7A is a perspective view of an inspection block according to the second embodiment.

FIG. 7B is a cross-sectional view of the inspection block according to the second embodiment.

FIG. 7C is a cross-sectional view of the inspection block according to the second embodiment.

FIG. 8 is an air circuit diagram when the inspection block according to the second embodiment is used.

FIG. 9A is a schematic diagram illustrating a state in which a tip mounting part is fitted to a second measurement hole of the inspection block.

FIG. 9B is a schematic diagram illustrating a state in which the tip mounting part is fitted to a first measurement hole of the inspection block.

FIG. 10 is a flowchart illustrating a method of determining whether a dispensing device is usable, according to the second embodiment.

FIG. 11 is a flowchart illustrating the method of determining whether the dispensing device is usable and a method of correcting a dispensing command value, according to the second embodiment.

### DESCRIPTION OF EMBODIMENTS

Hereinafter, embodiments of the present disclosure will be described with reference to the drawings. Note that, although the drawings shown below show specific embodiments in accordance with the present disclosure, these are provided for understanding the present disclosure and are not intended to limit the present disclosure in any way.

### First Embodiment

### <Example of Configuration of Automatic Analyzer>

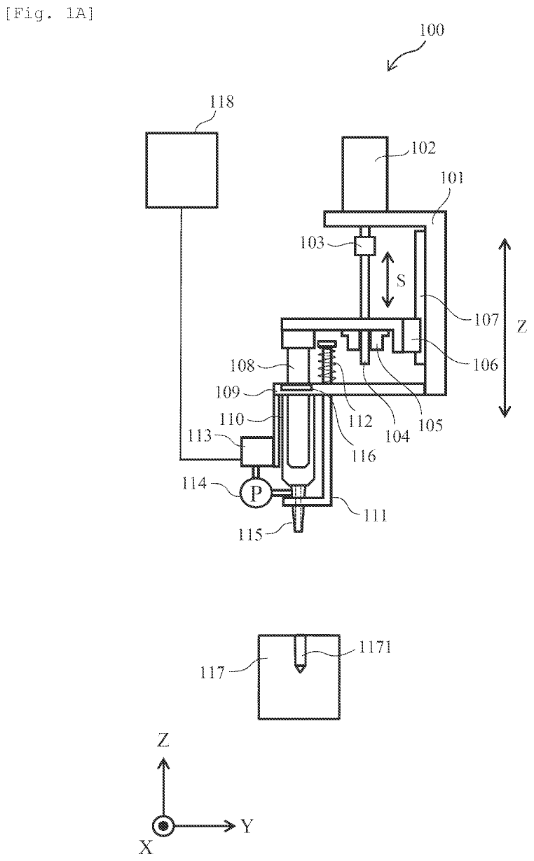

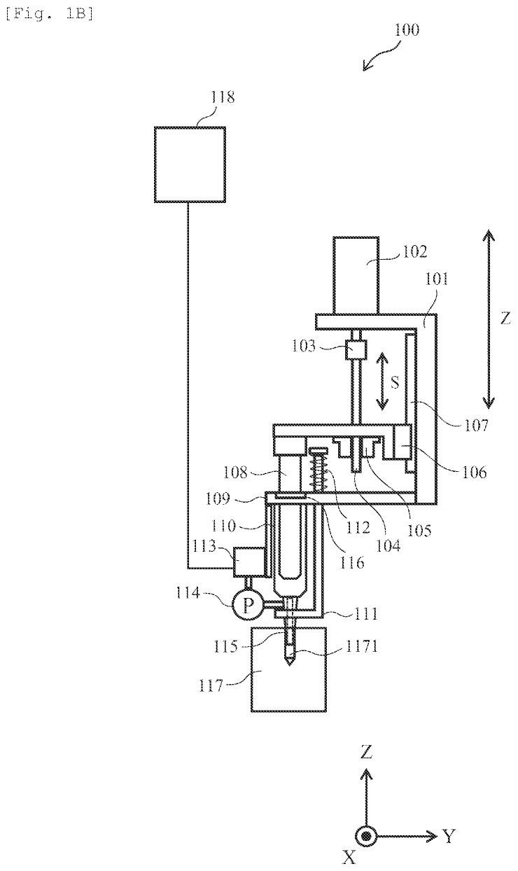

FIG. 1A is a schematic diagram illustrating a configuration of a dispensing apparatus 100 of an automatic analyzer according to a first embodiment. The automatic analyzer is an apparatus that automatically analyzes components of biological samples such as blood and urine. In FIG. 1, some constituent elements of the dispensing apparatus 100 are illustrated in cross section. The dispensing apparatus 100 collects a liquid from a sample container and a reagent container (not illustrated) mounted on the automatic analyzer and dispenses the liquid into a reaction container (not illustrated). The dispensing apparatus 100 is installed on an automatic stage (drive device) (not illustrated) that is configured to be driven in the horizontal direction (XY directions) and the vertical direction (Z direction).

The dispensing apparatus 100 includes a base 101, a motor 102, a coupling 103, a screw shaft 104, a nut 105, a slider 106, a linear guide 107, a piston 108, a syringe fixing base 109, a syringe 110, a tip removal portion 111, a spring material 112, an analysis unit 113, a pressure sensor 114, a tip mounting unit 115, a sealing component 116, an inspection block 117, and a computer 118.

The base 101 has a cross-section having an L-shape in the YZ plane. The motor 102 (drive device) is provided on the top portion of the base 101. The screw shaft 104 connected to a rotation shaft of the motor 102 via the coupling 103 is rotatably provided at the base 101. As the screw shaft 104, for example, a trapezoidal screw, a ball screw, or the like can be used.

The screw shaft 104 is provided with the slider 106 through which the screw shaft 104 passes, and the nut 105 screwed onto the screw shaft 104. One end portion of the slider 106 in the Y direction is connected to the linear guide 107 provided at the base 101 in the 2 direction. Each of the nut 105 and the slider 106 can move up and down a direction of an arrow Z (Z direction) illustrated in FIG. 1. In addition, the other end portion of the slider 106 in the Y direction is bonded to the piston 108 that protrudes downward and is configured to move up and down without rotating.

The syringe fixing base 109 is fixed to the lower end portion of the base 101. The syringe 110 is connected to the syringe fixing base 109. The syringe 110 receives the piston 108 inside. The tip mounting unit 115 is provided at the tip end of the syringe 110. The tip mounting unit 115 has a shape that tapers downward. For example, when an analysis operation of the automatic analyzer is started, the automatic stage that moves the dispensing apparatus 100 is driven, and a liquid dispensing tip (not illustrated) is mounted to the tip mounting unit 115.

The tip removal portion 111 is provided above the tip mounting unit 115. The tip removal portion 111 may be a U-shaped notch, or may be provided with a through-hole having a diameter smaller than the diameter of an opening portion of the tip. With the spring material 112 connected to the upper end of the tip removal portion 111 and the base 101, the tip removal portion 111 is configured to be normally urged upward and to freely move up and down in the Z direction. As the spring material 112, for example, a spring or the like can be used.

The piston 108 and the syringe 110 constitute a pipette mechanism, and serve as a pump by the above-described mechanism that moves up and down. In order to function as a pump, the sealing component 116 is assembled between the piston 108 that moves up and down and the syringe 110. The piston 108 has a shape of penetrating the sealing component 116, and can smoothly slide the piston 108. The piston 108 is sealed so that the dispensing apparatus 100 prevents air from flowing in or out of the dispensing apparatus 100 during the operation.

When the motor 102 is driven, the slider 106 and the piston 108 are operated. The pressure in the tube of the dispensing apparatus changes by operating the piston 108. The pressure sensor 114 is connected to the top portion of the tip mounting unit 115 and measures the change in pressure in the tube. Note that the phrase of “in the tube” means a space between the piston 108 and the syringe 110, an internal space of the tip mounting unit 115, and the inside of a connection tube between the tip mounting unit 115 and the pressure sensor 114. The pressure sensor 114 may include an A/D converter. The pressure sensor 114 outputs the measured pressure value to the analysis unit 113 in a form of an analog signal or a digital signal.

The analysis unit 113 (processing device) includes a processor and a storage device. The analysis unit 113 executes a program stored in a memory to store and analyze the pressure value measured by the pressure sensor 114 and to feed a correction command value back to the motor 102.

The inspection block 117 is used when the performance and the state of the sealing component inside the dispensing apparatus 100 are evaluated. The inspection block 117 may be detachably attached to the automatic analyzer, or may be fixed. The inspection block 117 has a hole 1171 to be fitted to the tip mounting unit 115. The inspection block 117 has mechanical strength that prevents plastic deformation due to fitting of the tip mounting unit 115. In FIG. 1, the inner diameter from the entrance of the hole 1171 to just before the tip end portion is constant, but the inner diameter may decrease downward. The inner diameter of the tip end portion of the hole 1171 decreases downward, and the tip end of the hole 1171 is closed.

Although not illustrated, the computer 118 (processing device) is any computer terminal including a processor, a memory, a storage device, a display device, and an input/output device. The processor of the computer 118 executes a program stored in the memory to control the operation of the entire automatic analyzer, and, in particular, to control driving of the motor 102 and the automatic stage. Note that the analysis unit 113 and the computer 118 may be configured as one computer terminal, or the computer 118 may be configured so that the functions of the analysis unit 113 can be realized.

FIG. 1B is a schematic diagram illustrating the state in which the tip mounting unit 115 is fitted to the hole 1171 of the inspection block 117. As illustrated in FIG. 1B, the outer diameter of the tip mounting unit above the tip end portion of the tip mounting unit 115 is approximately equal to the inner diameter of the entrance of the hole 1171, and the inside of the hole 1171 is sealed in a state where the tip mounting unit 115 and the hole 1171 are fitted to each other.

Note that instead of attaching the dispensing apparatus 100 to the automatic stage, a drive device may be connected to the base 101 to move the dispensing apparatus 100 in the horizontal direction and the vertical direction. Alternatively, instead of moving the dispensing apparatus 100, the inspection block 117 may be moved. That is, the configuration of the drive device is not limited as long as the relative position between the tip mounting unit 115 and the inspection block 117 can be changed.

<Method of Determining Whether dispensing device is Usable>

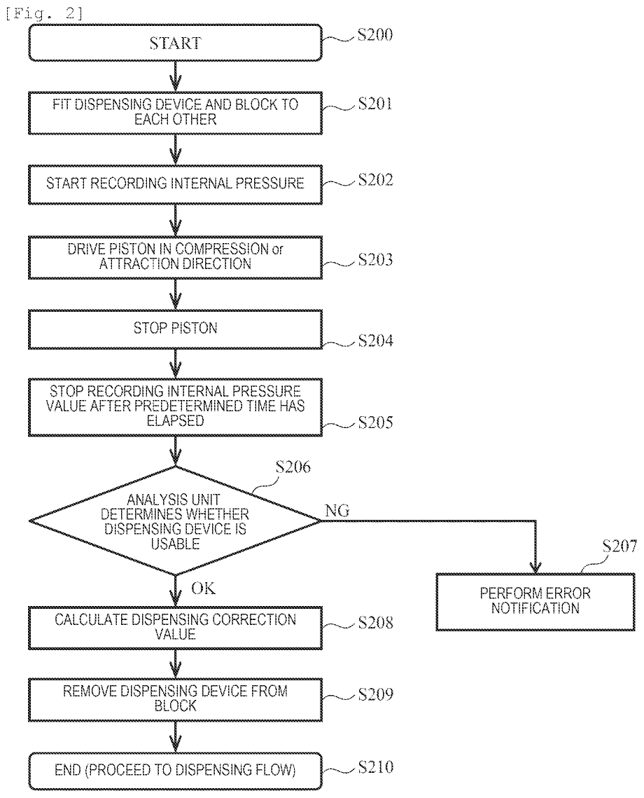

FIG. 2 is a flowchart illustrating a method of determining whether the dispensing apparatus 100 is usable and a method of correcting a dispensing command value.

### (Step S200)

The dispensing apparatus 100 is in a stopped state at the initial position illustrated in FIG. 1A. For example, when a user inputs an instruction to start determining whether the dispensing device 100 is usable, via the input device of the computer 118, the computer 118 of the automatic analyzer starts an operation of determining whether the dispensing device 100 is usable.

### (Step S201)

The computer 118 drives the automatic stage to move the dispensing apparatus 100 above the inspection block 117 and then to lower the dispensing apparatus 100, thereby fitting the tip mounting unit 115 of the dispensing apparatus 100 to the hole 1171 of the inspection block 117. By fitting, the interior of the tube is hermetically sealed.

### (Step S202)

The analysis unit 113 starts recording the pressure value in the tube measured by the pressure sensor 114.

### (Step S203)

The computer 118 drives the motor 102 to move the piston 108 in a compression direction (downward direction) or an attraction direction (upward direction). As a result, the state of the inside of the tube changes to a positive pressure state or a negative pressure state.

### (Step S204)

After moving the piston 108 by any movement amount, the computer 118 stops driving the motor 102 to stop the piston 108.

### (Step S205)

The analysis unit 113 stops recording the pressure value in the tube after a predetermined time has elapsed from the start of recording the pressure value in the tube. Instead of this step, the analysis unit 113 may measure a pressure value after a predetermined time has elapsed immediately after the tip mounting unit 115 is fitted to the inspection block 117, and a pressure value after a predetermined time has elapsed immediately after the piston 108 has been moved by any movement amount.

### (Step S206)

The analysis unit 113 determines whether there is an abnormality in the sealing component 116 of the dispensing apparatus 100 based on the recorded pressure value in the tube, and determines whether the dispensing apparatus 100 is usable. The details of determining whether the dispensing apparatus 100 is usable based on the pressure value will be described later. When it is determined that the dispensing apparatus 100 is not usable (NG), the process proceeds to Step S207. When it is determined that the dispensing apparatus 100 is usable (OK), the process proceeds to Step S208.

### (Step S207)

The analysis unit 113 transmits, to the computer 118, a signal indicating that the dispensing device 100 is not usable. The computer 118 generates an error notification screen and displays the generated error notification screen on the display device. The error notification screen may include a message for urging the user to perform maintenance on the dispensing apparatus 100.

### (Step S208)

The analysis unit 113 calculates a correction value for the dispensing command value based on the recorded pressure value, and corrects the dispensing command value. The dispensing command value is the movement amount of the piston 108 (drive amount of the motor 102) with respect to the desired liquid dispensing amount. The analysis unit 113 transmits the corrected dispensing command value to the computer 118. The corrected dispensing command value acquired in this step is used during the dispensing operation in the analysis operation of the automatic analyzer.

### (Step S209)

The computer 118 drives the automatic stage, moves the dispensing apparatus 100 upward, and removes the dispensing apparatus 100 from the inspection block 117.

### (Step S210)

The computer 118 ends the flow of determining whether the dispensing apparatus 100 is usable and correcting the dispensing command value, and proceeds to the analysis operation of the automatic analyzer. A known method can be adopted for the analysis operation of the automatic analyzer.

### <Method of Correcting Dispensing Command Value>

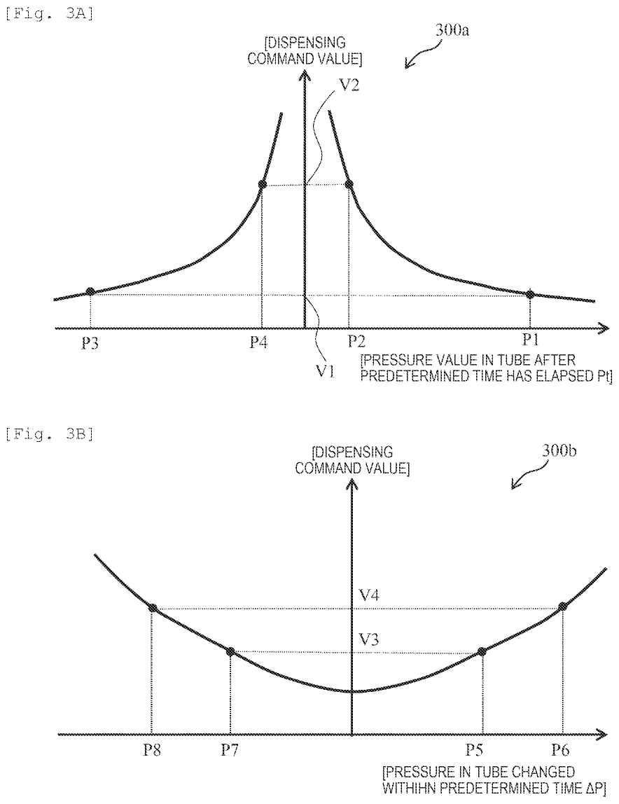

FIG. 3A is an example of a dispensing command value map 300a for determining the dispensing command value. The horizontal axis of the dispensing command value map 300a indicates a value Pt in the tube after a predetermined time has elapsed from the start of recording the pressure value. The vertical axis of the dispensing command value map 300a indicates an appropriate dispensing command value calculated in a dispensing amount test described later.

When positive pressure is applied to the inside of the dispensing apparatus 100 and the pressure value Pt in the tube after the predetermined time has elapsed from the start of recording the pressure value (Step S205) is P1 (P1>0), the appropriate dispensing command value is V1. When the pressure value Pt is P2 (P2>0, P1>P2), the appropriate dispensing command value is V2 (V1<V2). When negative pressure is applied to the inside of the dispensing apparatus 100 and the pressure value Pt is P3 (P3<0), the appropriate dispensing command value is V1. When the pressure value Pt is P4 (P4<0, |P3|>|P4|), the appropriate dispensing command value is V2.

As described above, when the absolute value of the pressure value Pt is large, the sealing component 116 is worn or deteriorated a little, and a difference between the dispensing command value, and the actual suction amount and discharge amount becomes small, so the dispensing command value may be small. On the other hand, when the absolute value of the pressure value Pt is small, the sealing component 116 has progressed to wear or deterioration, and the difference between the dispensing command value, and the actual suction amount and discharge amount becomes large, so the dispensing command value needs to be made large.

FIG. 3B is an example of a dispensing command value map 300b for determining the dispensing command value. Instead of the dispensing command value map 300a illustrated in FIG. 3A, the dispensing command value map 300b illustrated in FIG. 3B may be used to determine the dispensing command value. The horizontal axis of the dispensing command value map 300b indicates the amount of change ΔP in the pressure value in the tube changed within a predetermined time from the start of recording the pressure value.

When negative pressure is applied to the inside of the dispensing apparatus 100 and the amount of change ΔP in the pressure value in the tube within the predetermined time from the start of recording the pressure value is P5 (P5>0), the appropriate dispensing command value is V3. When the amount of change ΔP in the pressure value is P6 (P6>0, P5<P6), the appropriate dispensing command value is V4 (V3<V4). As described above, when the applied pressure is the negative pressure, ΔP transitions toward atmospheric pressure, so ΔP>0. When positive pressure is applied to the inside of the dispensing apparatus 100 and the amount of change ΔP in the pressure value is P7 (P7<0), the appropriate dispensing command value is V3. When the amount of change ΔP in the pressure value is P8 (P8<0, |P7|<|P8|), the appropriate dispensing command value is V4. When the applied pressure is the positive pressure, ΔP transitions toward the atmospheric pressure, so ΔP<0.

As described above, when the absolute value of the amount of change ΔP in the pressure value is large, the sealing component 116 has progressed to wear or deterioration, and the difference between the dispensing command value, and the actual suction amount and discharge amount becomes large, so the dispensing command value needs to be made large. On the other hand, when the absolute value of the amount of change ΔP in the pressure value is small, the sealing component 116 is worn or deteriorated a little, and a difference between the dispensing command value, and the actual suction amount and discharge amount becomes small, so the dispensing command value may be small.

The dispensing command value maps 300a and 300b may be stored in the storage device of the analysis unit 113, or may be stored in the storage device of the computer 118 and read out by the analysis unit 113 with communicating with the computer 118.

The dispensing command value maps 300a and 300b can be created by combining transitions in the pressure value measured under various conditions set in advance and results from dispensing tests. More specifically, the dispensing command value maps 300a and 300b can be created as follows. First, the tip mounting unit 115 of the dispensing apparatus 100 is fitted to the hole 1171 of the inspection block 117, and the piston 108 is driven to evaluate the pressure resistance of the sealing component 116. The pressure resistance evaluation can be performed either by applying positive pressure (compressing the piston 108) or applying negative pressure (attracting the piston 108).

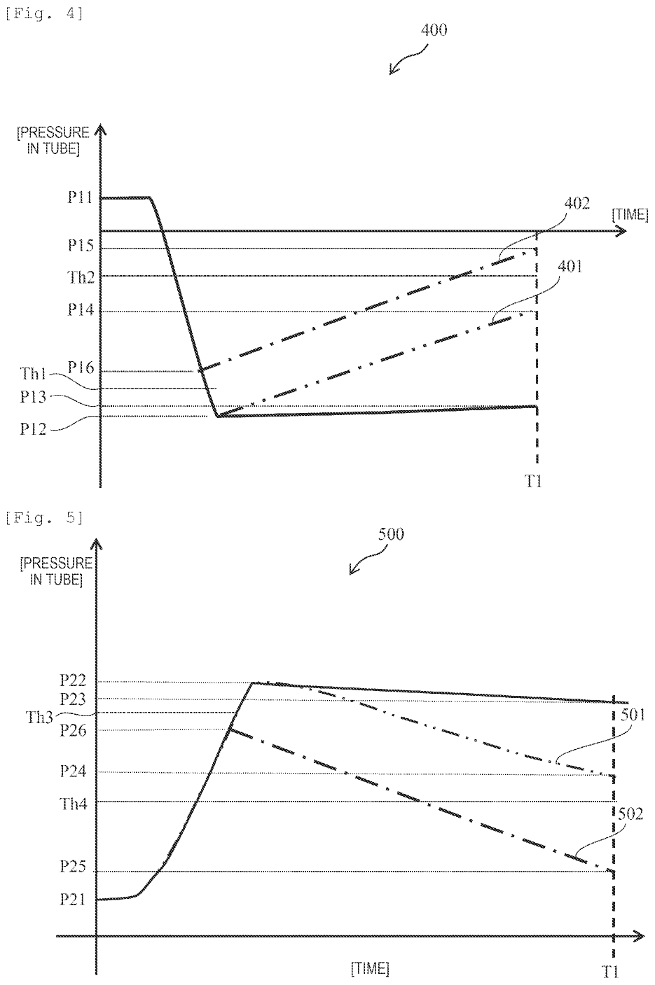

FIG. 4 is a graph showing a pressure value transition waveform 400 when negative pressure is applied into the tube in pressure resistance evaluation. A pressure value P11 when the tip mounting unit 115 and the inspection block 117 are fitted to each other is positive pressure. After the piston 108 is lifted by any amount (expansion), the pressure value decreases to P12 (P12<0). When wear or deterioration of the sealing component 116 has not progressed, the pressure value may increase slightly to a pressure value P13 at a time point T1 after a predetermined time has elapsed from the start of measuring the pressure value, but the pressure value may transition with remaining at the pressure value P12.

On the other hand, when the sealing component 116 has progressed to wear or deterioration, a pressure profile 401 indicated by the two-dot chain line may be obtained. In the pressure profile 401, a pressure value P14 (P14<0, P14>P13) is obtained at the time point T1, and changes to the atmospheric pressure side.

When the wear or deterioration of the sealing component 116 has progressed further, a pressure profile 402 indicated by the one-dot chain line may be obtained. In the pressure profile 402, a pressure value P15 (P15<0, P15>P14) is obtained at the time point T1, and changes to the atmospheric pressure side. As described above, when the piston 108 applies the any same operation (expansion) to the sealing components 116 that have different progress states of wear and deterioration, it is possible to use the difference in the measured pressure profiles.

When it is not possible for the sealing component 116 to sufficiently seal the inside of the dispensing apparatus 100 due to wear or deterioration, the pressure does not have the pressure value P12 that should originally be obtained, but decreases up to a pressure value P16 (P16<0, P16>P12) higher than an initial failure determination value Th1 (Th1>P12) when the piston 108 is lifted by any movement amount, as shown in the pressure profile 402. Further, at the time point T1, the pressure value P15 (P15<0) higher than a failure determination value Th2 (Th2>Th1) set in advance is obtained. In this case, since it is not possible to suck the liquid with high reproducibility, it is not possible to obtain dispensing reproducibility and it is difficult to solve the problem by correcting the dispensing command value.

On the other hand, when the sealing component 116 is slightly worn or deteriorated, as shown in the pressure profile 401, the pressure value (P12) when the piston 108 is lifted by any movement amount is lower than the initial failure determination value Th1, and the pressure value (P14) at the time point T1 is lower than the failure determination value Th2. In this case, handling is possible by correcting the dispensing command value. Since the liquid amount when the liquid is sucked decreases below the defined value, and the discharged liquid amount decreases and the liquid in the tip remains when the liquid is discharged, it is necessary to correct both a suction command value and a discharge command value.

As described above, by comparing the pressure value when the piston 108 is lifted by any movement amount to the initial failure determination value Th1, or comparing the pressure value at the time point T1 after the predetermined time has elapsed to the failure determination value Th2, it can be determined whether the sealing component 116 has failed (is worn or deteriorated).

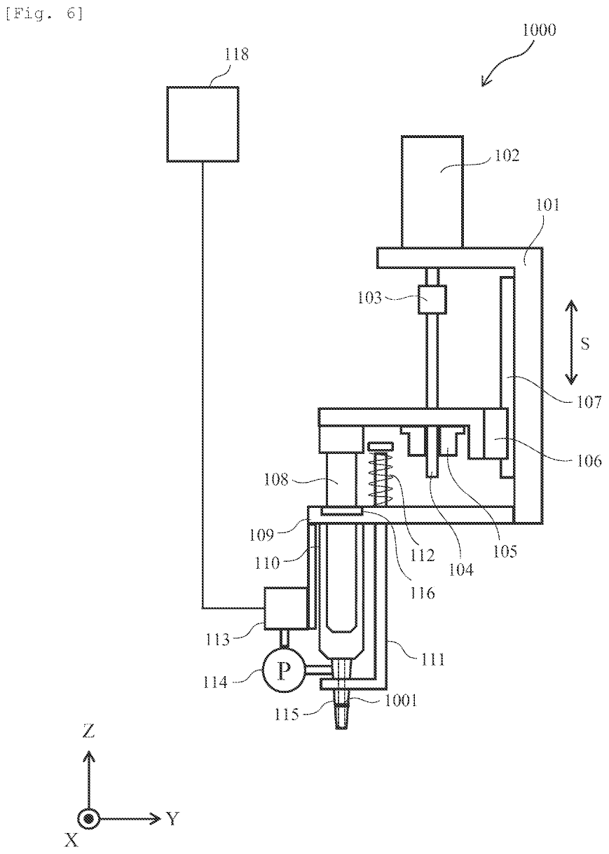

FIG. 5 is a graph showing a pressure value transition waveform 500 when positive pressure is applied into the tube in pressure resistance evaluation. A pressure value P21 when the tip mounting unit 115 and the inspection block 117 are fitted to each other is positive pressure. After the piston 108 is lowered by any movement amount (compression), the pressure value increases up to a pressure value P22 (P22>0). When wear or deterioration of the sealing component 116 has not progressed, the pressure value may decrease slightly to a pressure value P23 at the time point T1 after a predetermined time has elapsed from the start of measuring the pressure value, but the pressure value may transition with remaining at the pressure value P22.

On the other hand, when the sealing component 116 has progressed to wear or deterioration, a pressure profile 501 indicated by the two-dot chain line may be obtained. In the pressure profile 501, a pressure value P24 (P24>0, P24<P23) is obtained at the time point T1, and changes to the atmospheric pressure side.

When the wear or deterioration of the sealing component 116 has progressed further, a pressure profile 502 indicated by the one-dot chain line may be obtained. In the pressure profile 502, a pressure value P25 (P25>0, P25<P24) is obtained at the time point T1, and changes to the atmospheric pressure side. As described above, similarly to the case when the negative pressure is applied, when the piston 108 applies the any same operation (compression) to the sealing components 116 that have different progress states of wear and deterioration, it is possible to use the difference in the measured pressure profiles.

When it is not possible for the sealing component 116 to sufficiently seal the inside of the dispensing apparatus 100 due to wear or deterioration, the pressure does not have the pressure value P22 that should originally be obtained, but increases up to a pressure value P26 lower than an initial failure determination value Th3 (Th3<P22) when the piston 108 is lowered by any movement amount, as shown in the pressure profile 502. Further, at the time point T1, the pressure value P25 (P25>0) lower than a failure determination value Th4 (Th4<Th3) set in advance is obtained. In this case, since it is not possible to discharge the liquid with high reproducibility, it is not possible to obtain dispensing reproducibility and it is difficult to solve the problem by correcting the dispensing command value.

On the other hand, when the sealing component 116 is slightly worn or deteriorated, as shown in the pressure profile 501, the pressure value (P22) when the piston 108 is lowered by any movement amount is higher than the initial failure determination value Th3, and the pressure value (P24) at the time point T1 is higher than the failure determination value Th4. In this case, handling is possible by correcting the dispensing command value. Since the liquid amount when the liquid is sucked decreases below the defined value, and the discharged liquid amount decreases and the liquid in the tip remains when the liquid is discharged, it is necessary to correct a command value together with both the suction command value and the discharge command value.

As described above, by comparing the pressure value when the piston 108 is lowered by any movement amount to the initial failure determination value Th3, or comparing the pressure value at the time point T1 after the predetermined time has elapsed to the failure determination value Th4, it can be determined whether the sealing component 116 has failed (is worn or deteriorated).

Next to the pressure resistance test, a dispensing amount test is performed on the dispensing apparatus 100 equipped with the sealing component 116 under wear or deterioration conditions to test the actual dispensing amount with respect to the dispensing command value. As a method of the dispensing amount test, for example, a gravimetric method, a fluorescence amount analysis method, and the like can be selected. The gravimetric method is a method in which the weights of the liquid before and after dispensing are weighed by using an analytical balance. The fluorescence amount analysis method is a method of evaluating the amount of dispensed liquid by measuring the intensity of light with a photometer.

A method of calculating the correction value from the results of the dispensing amount test will be described by using, as an example, the pressure resistance evaluation illustrated in FIG. 4. The dispensed liquid amount of the dispensing apparatus 100 in which the pressure value at the time point T1 after a predetermined time has elapsed reaches P14 is insufficient with respect to the dispensing command value. A necessary correction value can be calculated based on the insufficient amount with respect to the dispensing command value for the dispensed liquid amount calculated from the dispensing amount test. The sum of the dispensed liquid amount calculated from the dispensing amount test and the correction value serves as the appropriate dispensing command value. The dispensing command value map can be obtained by performing the above test on the dispensing apparatus 100 in various wear and deterioration states and creating an approximate curve from the accumulated data.

### Summary of First Embodiment

As described above, the dispensing device 100 according to the first embodiment includes the piston 108, the motor 102 (first drive device) that drives the piston 108, the syringe 110 that has the tip mounting part 115 to which the dispensing tip is attached, and receives the piston 108, the pressure sensor 114 that measures the pressure in the syringe 110, the analysis unit 113 and the computer 118 (processing device) that process the detection signal of the pressure measured by the pressure sensor 114, the inspection block 117 having the hole 1171 to which the tip mounting part 115 is able to be fitted, and the automatic stage (second drive device) that varies the relative position between the syringe 110 and the inspection block 117.

As described above, by hermetically sealing the interior of the tube with the inspection block 117, applying pressure, and measuring the pressure after the pressure is applied, it can be identified that there is an abnormality in the sealing component in the dispensing device 100.

### Second Embodiment

FIG. 6 is a schematic diagram illustrating a configuration of a dispensing device 1000 according to a second embodiment. The dispensing device 1000 differs from the dispensing device in the first embodiment in that the tip mounting part 115 has a groove (not illustrated), and a groove portion is provided with an elastic member 1001 having wear resistance. The elastic member 1001 is fitted to a tip and hermetically seals the tip and the tip mounting part 115.

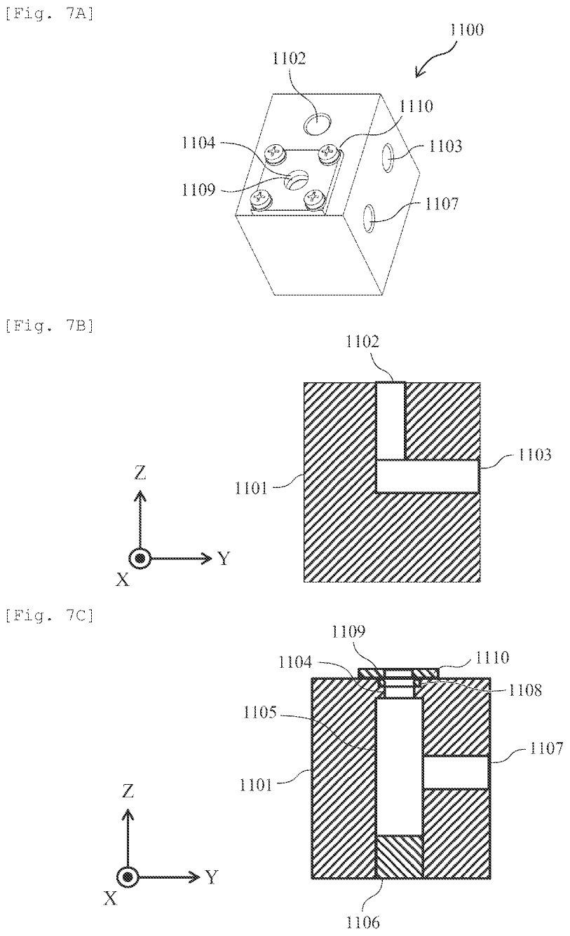

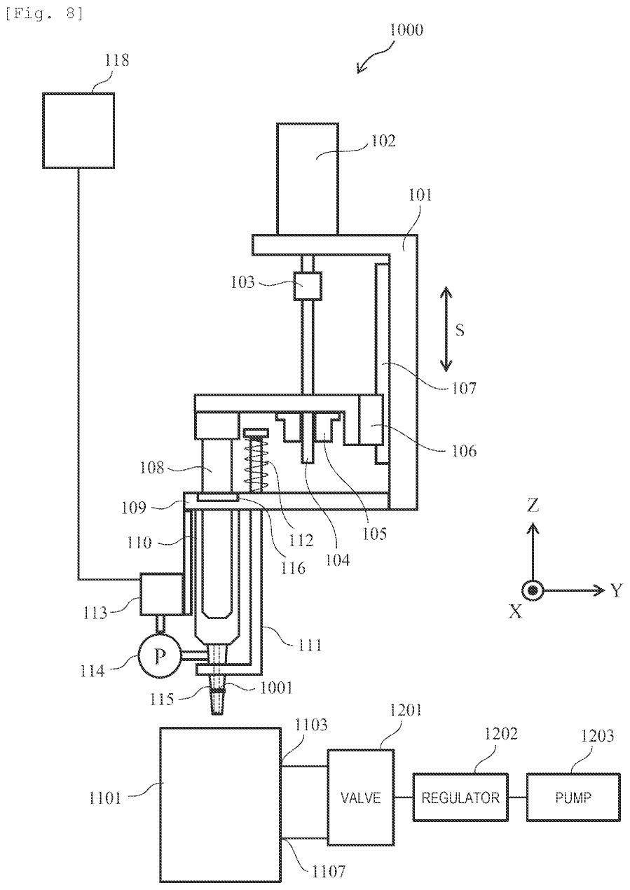

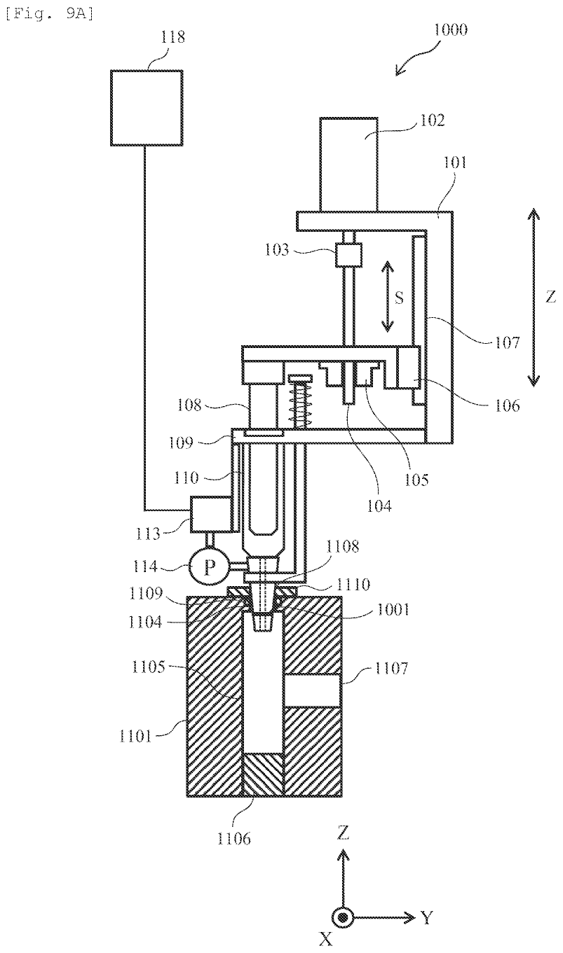

FIG. 7A is a perspective view of an inspection block 1101 according to the second embodiment. The inspection block 1101 includes a first measurement hole 1102, a flow path 1103, a second measurement hole 1104, a flow path 1107, an elastic member 1109, and a pressing plate 1110. The first measurement hole 1102 communicates with the flow path 1103. The second measurement hole 1104 communicates with the flow path 1107. The elastic member 1109 has wear resistance and is mounted near the entrance of the second measurement hole 1104. The pressing plate 1110 is fixed to the inspection block 1101 to press the elastic member 1109 from above. The pressing plate 1110 has a through-hole that communicates with the second measurement hole 1104.

FIG. 7B is a cross-sectional view of the inspection block 1101 in a plane passing through the first measurement hole 1102 and the flow path 1103. As illustrated in FIG. 7B, the first measurement hole 1102 and the flow path 1103 constitute one orifice that penetrates the interior of the inspection block 1101 in an L-shape. Note that, instead of connecting the first measurement hole 1102 and the flow path 1103 to form an L-shaped orifice, only the first measurement hole 1102 that penetrates the interior of the inspection block 1101 in a straight line may be provided.

FIG. 7C is a cross-sectional view of the inspection block 1101 in a plane passing through the second measurement hole 1104 and the flow path 1107. As illustrated in FIG. 7C, the second measurement hole 1104 is connected to a sealing side hole 1105 having a larger diameter than the second measurement hole 1104. The flow path 1107 is branched approximately perpendicularly from the sealing side hole 1105. An opening portion of the sealing side hole 1105 on an opposite side of the second measurement hole 1104 is sealed by a sealing member 1106. A groove 1108 is provided near the entrance of the second measurement hole 1104, and the elastic member 1109 is mounted to the groove 1108. Note that, instead of providing the flow path 1107, the sealing side hole 1105 may be opened without providing the sealing member 1106.

FIG. 8 is an air circuit diagram when the inspection block 1101 is used. As illustrated in FIG. 8, the inspection block 1101 is connected to a pump 1203 via a valve 1201 and a regulator 1202. The valve 1201 has two outlet pipes, and the respective outlet pipes are connected to the flow path 1103 (first measurement hole 1102) and the flow path 1107 (second measurement hole 1104). The valve 1201 switches the air circuit between a direction of the first measurement hole 1102 and a direction of the second measurement hole 1104, or cuts off the flow path. The regulator 1202 and the pump 1203 are connected to the inlet side of the valve 1201.

The valve 1201 can communicate or cut off an air circuit between the inspection block 1101 and the regulator 1202. The pump 1203 can generate and apply positive pressure or negative pressure into the tube. By using the pump 1203 together with an ejector system or the like, it is also possible to selectively apply the positive pressure or the negative pressure. When the generated pressure can be controlled by the pump 1203, the regulator 1202 may be omitted.

A computer 118 controls operations of the valve 1201, the regulator 1202, and the pump 1203.

<Method of Determining Whether dispensing device is Usable>

When a liquid is dispensed by the dispensing device, a tip is mounted to the tip mounting part 115, and the liquid is sucked into the tip and discharged. The tip may be replaced each time a sample to be dispensed changes, or may be replaced with a tip of an appropriate capacity when the dispensing amount is changed. In general, the tip is used as a disposable tip. Therefore, the tip is frequently attached and detached, and the elastic member 1001 mounted to the tip mounting part 115 is worn out due to friction with the tip. As the wear progresses, the sealing performance between the mounted tip and elastic member 1001 decreases, and the accuracy of dispensing decreases. When the wear progresses further, dispensing reproducibility is no longer obtained, and eventually it is difficult to suck the liquid. Therefore, in the present embodiment, the wear state of the elastic member 1001 is evaluated based on the measurement results of the pressure when the tip mounting part 115 is fitted to each of the first measurement hole 1102 and the second measurement hole 1104, and it is determined whether the dispensing device 1000 is usable. When the dispensing device is usable, the dispensing command value is corrected and reflected in the dispensing operation.

First, the wear state and deterioration state of the sealing component 116 of the dispensing device 1000 can be evaluated by using the second measurement hole 1104, and then the wear state of the elastic member 1001 can be evaluated by using the first measurement hole 1102. Although the order of evaluating the sealing component 116 and the elastic member 1001 is not particularly limited, a case where the state of the sealing component 116 is evaluated first will be described below.

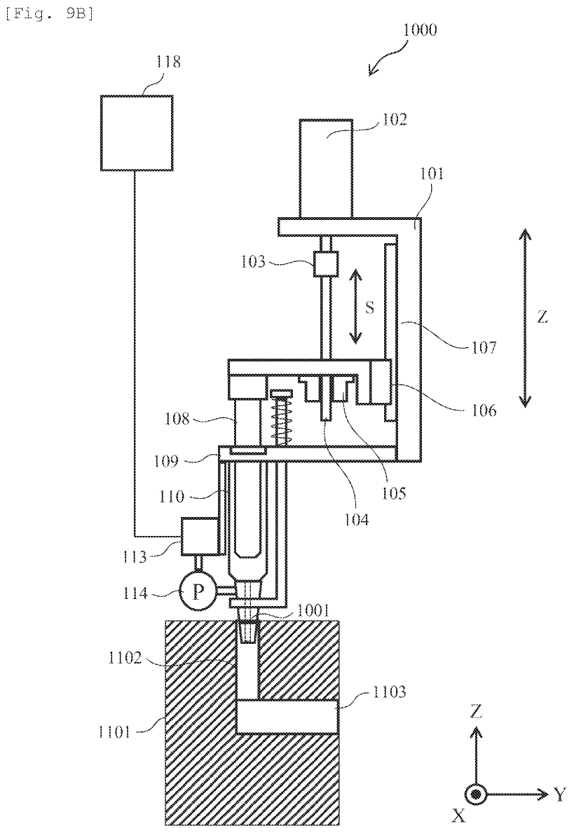

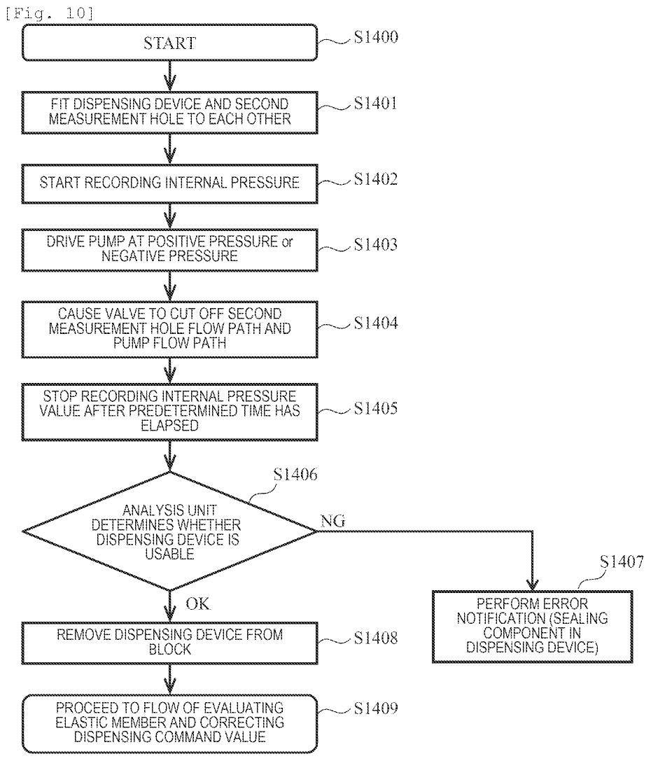

FIG. 9A is a diagram illustrating a state in which the tip mounting part 115 is fitted to the second measurement hole 1104. As illustrated in FIG. 9A, in a state where the tip mounting part 115 and the second measurement hole 1104 are fitted to each other, the elastic member 1001 mounted to the tip mounting part 115 is located in the sealing side hole 1105. That is, the outer diameter of the elastic member 1001 is smaller than the inner diameter of the second measurement hole 1104 and the inner diameter of the elastic member 1109. In addition, during fitting, the elastic member 1001 passes through the second measurement hole 1104 without coming into contact with the second measurement hole 1104 or the elastic member 1109. The inner diameter of the elastic member 1109 is approximately equal to the outer diameter of a portion of the tip mounting part 115 above the elastic member 1109, and the interior of the tube is sealed by being in close contact with this portion.

FIG. 9B is a diagram illustrating a state in which the tip mounting part 115 is fitted to the first measurement hole 1102. As illustrated in FIG. 9B, the inner diameter of the first measurement hole 1102 is approximately equal to the outer diameter of the elastic member 1109. When the tip mounting part 115 and the first measurement hole 1102 are fitted to each other, the opening portion of the first measurement hole 1102 is sealed by the elastic member 1109.

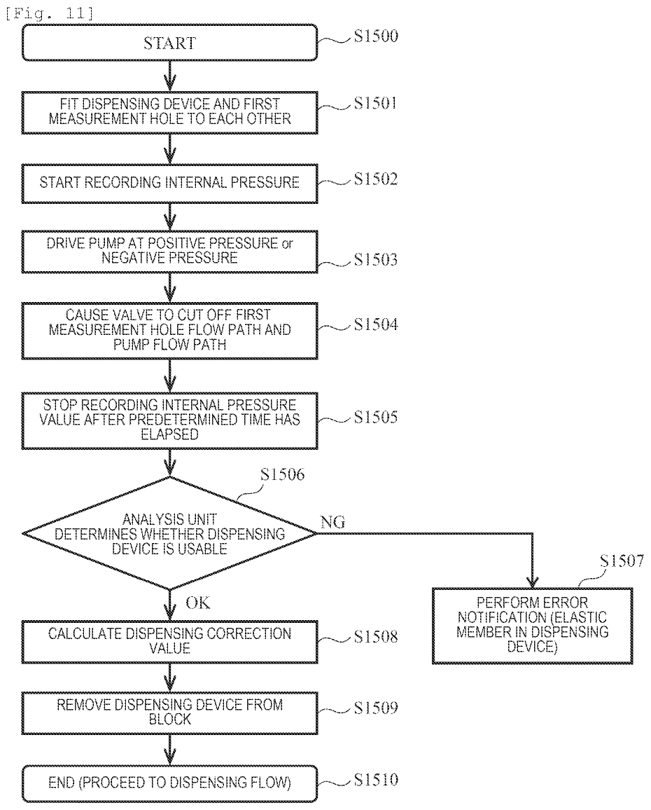

FIG. 10 is a flowchart illustrating a method of determining whether the sealing component 116 of the dispensing device 1000 is usable.

### (Step S1400)

The dispensing device 1000 is in a stopped state at the initial position illustrated in FIG. 8. For example, when a user inputs an instruction to start determining whether the dispensing device 1000 is usable, via the input device of a computer 118, the computer 118 of the automatic analyzer starts an operation of determining whether the dispensing device 1000 is usable.

### (Step S1401)

The computer 118 drives the automatic stage, moves the dispensing device 1000 so that the tip mounting part 115 is located above the second measurement hole 1104 of the inspection block 1101, and then lowers the dispensing device 1000. In this manner, the tip mounting part 115 is fitted to the second measurement hole 1104. By fitting, the interior of the tube is hermetically sealed. At this time, the second measurement hole 1104, the valve 1201, the regulator 1202, and the pump 1203 are in communication with each other. The flow path 1103 on the first measurement hole 1102 side is opened to the atmosphere by a valve 1201. The regulator 1202 is set to have any pressure value, and the pressure value applied to the interior of the tube is set in advance.

### (Step S1402)

Step S1402 is similar to Step S202 described in the first embodiment with reference to FIG. 2, so the description thereof will be omitted.

### (Step S1403)

The computer 118 drives the pump 1203 to apply either positive pressure or negative pressure into the tube.

### (Step S1404)

After the pressure value has reached a pressure value set by the regulator 1202, the computer 118 drives the valve 1201 to cut off the flow path connecting the second measurement hole 1104 and the pump 1203.

(Steps S1405 and S1406) Steps S1405 and S1406 are similar to Steps S205 and S206 described in the first embodiment with reference to FIG. 2, so the description thereof will be omitted. Here, the pressure value at a time point when a predetermined time has elapsed in Step S1405 is set as P_{A}.

### (Step S1407)

When it is determined in Step S1406 that the dispensing device 1000 is not usable, the analysis unit 113 transmits, to the computer 118, a signal indicating that the dispensing device 100 is not usable. The computer 118 generates an error notification screen indicating that the sealing component 116 is worn or deteriorated, and causes the display device to display the error notification screen. The error notification screen may include a message for urging the user to perform maintenance on the sealing component 116 of the dispensing device 100.

### (Step S1408)

When it is determined in Step S1406 that the dispensing device 1000 is usable, the computer 118 drives the automatic stage, moves the dispensing device 1000 upward, and removes the dispensing device 1000 from the inspection block 1101.

### (Step S1409)

The computer 118 ends determination as to whether the sealing component 116 of the dispensing device 100 is usable, and then proceeds to determination as to whether the elastic member 1001 is usable and correction of the dispensing command value.

FIG. 11 is a flowchart illustrating a method of determining whether the elastic member 1001 of the dispensing device 100 is usable and a method of correcting a dispensing command value.

### (Step S1500)

The dispensing device 1000 is in a state in which the tip mounting part 115 is located above the second measurement hole 1104 of the inspection block 1101.

### (Step S1501)

The computer 118 drives the automatic stage, moves the dispensing device 1000 so that the tip mounting part 115 is located above the first measurement hole 1102 of the inspection block 1101, and then lowers the dispensing device 1000. In this manner, the tip mounting part 115 is fitted to the first measurement hole 1102. By fitting, the interior of the tube is hermetically sealed. At this time, the first measurement hole 1102, the valve 1201, the regulator 1202, and the pump 1203 are in communication with each other. The flow path 1107 on the second measurement hole 1104 side is opened to the atmosphere by the valve 1201. The regulator 1202 is set to have any pressure value, and the pressure value applied to the interior of the tube is set in advance.

### (Steps S1502 and S1503)

Steps S1502 and S1503 are similar to Steps S1402 and S1403 described with reference to FIG. 10, so the description thereof will be omitted. Note that, when positive pressure is applied in Step S1403, the positive pressure is also applied in Step S1503, and when negative pressure is applied in Step S1403, the negative pressure is also applied in Step S1503.

### (Step S1504)

After the pressure value has reached a pressure value set by the regulator 1202, the computer 118 drives the valve 1201 to cut off the flow path connecting the first measurement hole 1102 and the pump 1203.

### (Step S1505)

Step S1505 is similar to Step S205 described in the first embodiment with reference to FIG. 2, so the description thereof will be omitted. Here, the pressure value at a time point when a predetermined time has elapsed in Step S1505 is set as P_{B}.

### (Step S1506)

The analysis unit 113 determines whether there is an abnormality in the sealing component 116 of the dispensing device 100 based on the recorded pressure values P_{A} and P_{B} in the tube, and determines whether the dispensing device 1000 is usable. The details of determining whether the dispensing device 1000 is usable based on the pressure values P_{A} and P_{B} will be described later. When it is determined that the dispensing device 1000 is not usable (NG), the process proceeds to Step S1507. When it is determined that the dispensing device 1000 is usable (OK), the process proceeds to Step S1508.

### (Step S1507)

The analysis unit 113 transmits, to the computer 118, a signal indicating that the dispensing device 100 is not usable. The computer 118 generates an error notification screen indicating that the elastic member 1001 is worn or deteriorated, and causes the display device to display the error notification screen. The error notification screen may include a message for urging the user to perform maintenance on the elastic member 1001 of the dispensing device 100.

### (Step S1508)

The analysis unit 113 calculates the correction value for the dispensing command value based on the recorded pressure value P_{B} and the dispensing command value map in FIG. 3A or FIG. 3B, and corrects the dispensing command value.

### (Steps S1509 and S1510)

Steps S1509 and S1510 are similar to Steps S209 and S210 described with reference to FIG. 2, so the description thereof will be omitted.

### <Details of Method of Determining Whether Dispensing Device is Usable>

The method of determining whether the dispensing device 1000 is usable based on the pressure values P_{A} and P_{B} in Step S1506 described above will be described separately for the time when negative pressure is applied and the time when positive pressure is applied.

### (When Negative Pressure is Applied)

(i) When there is no abnormality in the sealing component 116 and there is no abnormality in the elastic member 1001, the pressure value becomes P_{A}=P_{B}=the pressure applied by the pump 1203. In this case, it can be determined that the dispensing device 1000 is usable.
(ii) When the sealing component 116 is worn and there is no abnormality in the elastic member 1001, the pressure value becomes P_{A}=P_{B}. However, the pressure values P_{A} and P_{B} are closer to atmospheric pressure than the pressure applied by the pump 1203. For example, when the pressure applied by the pump 1203 is set to −20 kPa, the pressure values P_{A} and P_{B} become −19 kPa. In this case, when the pressure values P_{A} and P_{B} do not exceed the failure determination value (failure determination value Th2 in FIG. 4), it can be determined that the dispensing device 1000 is usable.
(iii) When there is no abnormality in the sealing component 116 and the elastic member 1001 is worn, the pressure value becomes P_{A}<P_{B}. For example, when the pressure applied by the pump 1203 is set to −20 kPa, the pressure value P_{A} becomes −20 kPa, which is the same as the applied pressure, and the pressure value PE becomes −19 kPa. In this case, when the pressure value P_{B} does not exceed the failure determination value (failure determination value Th2), it can be determined that the dispensing device 1000 is usable.
(iv) When the sealing component 116 is worn and the elastic member 1001 is also worn, the pressure value becomes P_{A}<P_{B}. Further, the pressure values P_{A} and P_{B} are different from the pressure applied by the pump 1203. For example, when the pressure applied by the pump 1203 is set to −20 kPa, the pressure value P_{A} becomes −19.5 kPa, and the pressure value Pp becomes −19.0 kPa. In this case, when the pressure values P_{A} and P_{B} do not exceed the failure determination value (failure determination value Th2), it can be determined that the dispensing device 1000 is usable. Note that, even when only the pressure value P_{A} has reached the failure determination value, it is determined that the dispensing device 1000 is usable.

### (When Positive Pressure is Applied)

(i) When there is no abnormality in the sealing component 116 and there is no abnormality in the elastic member 1001, the pressure value becomes P_{A}=P_{B}=the pressure applied by the pump 1203. In this case, it can be determined that the dispensing device 1000 is usable.
(ii) When the sealing component 116 is worn and there is no abnormality in the elastic member 1001, the pressure value becomes P_{A}=Pp. However, the pressure values P_{A} and P_{B} are closer to atmospheric pressure than the pressure applied by the pump 1203. For example, when the pressure applied by the pump 1203 is set to 30 kPa, the pressure values P_{A} and P_{B} become 29 kPa. In this case, when the pressure values P_{A} and P_{B} do not exceed the failure determination value (failure determination value Th4 in FIG. 5), it can be determined that the dispensing device 1000 is usable.
(iii) When there is no abnormality in the sealing component 116 and the elastic member 1001 is worn, the pressure value becomes P_{A}>P_{B}. For example, when the pressure applied by the pump 1203 is set to 30 kPa, the pressure value P_{A} becomes 30 kPa, which is the same as the applied pressure, and the pressure value P_{B} becomes 29 kPa. In this case, when the pressure value P_{B} does not exceed the failure determination value (failure determination value Th4), it can be determined that the dispensing device 1000 is usable.
(iv) When the sealing component 116 is worn and the elastic member 1001 is also worn, the pressure value becomes P_{A}>P_{B}. Further, the pressure values P_{A} and PE are different from the pressure applied by the pump 1203. For example, when the pressure applied by the pump 1203 is set to 30 kPa, the pressure value P_{A} becomes 29.5 kPa, and the pressure value P_{B} becomes 29.0 kPa. In this case, when the pressure values P_{A} and P_{B} do not exceed the failure determination value (failure determination value Th4), it can be determined that the dispensing device 1000 is usable. Note that, even when only the pressure value P_{A} has reached the failure determination value, it is determined that the dispensing device 1000 is usable.

As described above, in the present embodiment, the case where the state of the sealing component 116 is evaluated first, and then the state of the elastic member 1001 is evaluated has been described. When the elastic member 1001 is evaluated first, it is not possible to determine whether the dispensing device 1000 is usable unless the sealing component 116 in the dispensing device 1000 is inevitably evaluated. However, the sealing component 116 is evaluated first, and thus, when there is an abnormality in the sealing component 116, an error occurs, and the elastic member 1001 is not evaluated. Accordingly, it is possible to shorten the evaluation time.

### Summary of Second Embodiment

As described above, the dispensing device 1000 according to the second embodiment fits the tip mounting part 115 and the second measurement hole 1104 (first orifice) each other, hermetically seals the interior of the tube, and drives the pump 1203 to apply positive pressure or negative pressure into the tube. Then, the dispensing device 1000 fits the tip mounting part 115 and the first measurement hole 1102 (second orifice), hermetically seals the interior of the tube, drives the pump 1203 to apply positive pressure or negative pressure into the tube, and identifies a site of abnormality requiring the maintenance based on the pressure value P_{A} (first pressure) in the tube after the pressure is applied when the tip mounting part and the first orifice are fitted to each other, and the pressure value P_{B} (second pressure) in the tube after the pressure is applied when the tip mounting part and the second orifice are fitted to each other.

As described above, by executing the inspection procedure with the two-step pressure application, it is possible to determine whether the dispensing device 1000 is usable first (whether there is no abnormality in the sealing component 116), and whether a component requiring the maintenance is the sealing component 116 or the elastic member 1001.

### Modification Example

The present disclosure is not limited to the embodiments described and includes above, various modification examples. For example, the embodiments described above have been described in detail to describe the present disclosure in an easy-to-understand manner, and do not necessarily include all of the configurations described. In addition, a portion of one embodiment can be replaced with the configuration of another embodiment. Moreover, the configuration of one embodiment can be added to the configuration of another embodiment. Further, a portion of the configuration of each embodiment can be added to, deleted from, or replaced with a portion of the configuration of other embodiments.

### REFERENCE SIGNS LIST

100, 1000: dispensing device
101: base
102: motor
103: coupling
104: screw shaft
105: nut
106: slider
107: linear guide
108: piston
109: syringe fixing base
110: syringe
111: tip removal portion
112: spring material
113: analysis unit
114: pressure sensor
115: tip mounting unit
116: sealing component
117, 1101: inspection block
118: computer
1001: elastic member
1102: first measurement hole
1103, 1107: flow path
1104: second measurement hole
1105: sealing side hole
1106: sealing member
1108: groove
1109: elastic member
1110: pressing plate
1201: valve
1202: regulator
1203: pump

1. A dispensing device configured to dispense a liquid, the device comprising:
a piston;
a first drive device that drives the piston;
a syringe that has a tip mounting part having an elastic member for mounting a dispensing tip and receives the piston;
a pressure sensor that measures pressure in the syringe;
a processing device that processes a detection signal of the pressure measured by the pressure sensor;
a block having a first orifice and a second orifice that are able to be fitted to the tip mounting part;
a pump connected to the first orifice and the second orifice; and
a second drive device that varies a relative position between the syringe and the block,
wherein the processing device
drives the second drive device to fit the tip mounting part and the first orifice to each other, hermetically seals an interior of the syringe, and drives the pump to apply positive pressure or negative pressure into the syringe,
then, drives the second drive device to fit the tip mounting part and the second orifice to each other, hermetically seals the interior of the syringe, and drives the pump to apply the positive pressure or the negative pressure into the syringe, and
identifies a site of deterioration in the dispensing device based on first pressure in the syringe after the positive pressure or negative pressure is applied when the tip mounting part and the first orifice are fitted to each other and second pressure in the syringe after the positive pressure or the negative pressure is applied when the tip mounting part and the second orifice are fitted to each other.

2. The dispensing device according to claim 1, wherein
the elastic member passes through the first orifice when the tip mounting part and the first orifice are fitted to each other, and is brought into close contact with the second orifice when the tip mounting part and the second orifice are fitted to each other.

3. The dispensing device according to claim 1, wherein
the processing device calculates a correction value for a dispensing command value associated with a drive amount of the first drive device based on the second pressure.

4. The dispensing device according to claim 3, wherein
the processing device calculates the correction value by using a dispensing command value map indicating a relationship between the second pressure and the dispensing command value for obtaining a desired dispensing amount.

5. The dispensing device according to claim 3, wherein
the processing device
determines whether the dispensing device is usable based on the first pressure and the second pressure,
calculates the correction value when the dispensing device is usable, and
outputs an error to an output device when the dispensing device is not usable.

6. The dispensing device according to claim 5, wherein
when both the first pressure and the second pressure are equal to pressure applied by the pump, the processing device determines that the dispensing device is usable.

7. The dispensing device according to claim 5, wherein
in a case where the first pressure and the second pressure are equal to each other and are closer to atmospheric pressure than pressure applied by the pump, when the first pressure and the second pressure have values closer to the atmospheric pressure than a predetermined threshold value,
the processing device determines that the dispensing device is not usable.

8. The dispensing device according to claim 5, wherein
in a case where the first pressure is equal to pressure applied by the pump and the second pressure is different from the pressure applied by the pump, when the second pressure has a value closer to atmospheric pressure than a predetermined threshold value,
the processing device determines that the dispensing device is not usable.

9. The dispensing device according to claim 5, wherein
in a case where the first pressure is different from the second pressure and both the first pressure and the second pressure are different from pressure applied by the pump, when the first pressure and the second pressure have values closer to atmospheric pressure than a predetermined threshold value,
the processing device determines that the dispensing device is not usable.

10. A dispensing method performed by a processing device of a dispensing apparatus including a first drive device that drives a piston, and a second drive device that varies a relative position between a syringe that receives the piston and a block having a first orifice and a second orifice that are able to be fitted to a tip mounting part having an elastic member in the syringe, the method comprising:
by the processing device,
driving the second drive device to fit the tip mounting part and the first orifice to each other, hermetically sealing an interior of the syringe, and driving a pump connected to the first orifice and the second orifice to apply positive pressure or negative pressure into the syringe;
then, driving the second drive device to fit the tip mounting part and the second orifice to each other, hermetically sealing the interior of the syringe, and driving the pump to apply positive pressure or negative pressure into the syringe; and
identifying a site of deterioration in the dispensing device based on first pressure in the syringe after the positive pressure or negative pressure is applied when the tip mounting part and the first orifice are fitted to each other and second pressure in the syringe after the positive pressure or negative pressure is applied when the tip mounting part and the second orifice are fitted to each other, the first pressure and the second pressure being measured by a pressure sensor of the dispensing device.
